(19) United States
(12) Patent Application Publication
(10) Pub. No.: US 2016/0206172 A1
(43) Pub. Date: Jul. 21, 2016

(54) CLEANING DEVICE

(71) Applicant: ENVIRONMENTAL SOLUTIONS INTERNATIONAL, Batavia, IL (US)

(72) Inventors: Kent L. PULLEN, Downers Grove, IL (US); Kenneth ARNSWALD, Downers Grove, IL (US)

(21) Appl. No.: 15/023,603

(22) PCT Filed: Sep. 29, 2014
(86) PCT No.: PCT/US14/58135

§ 371 Date: Mar. 21, 2016

Related U.S. Application Data
(60) Provisional application No. 61/884,894, filed on Sep. 30, 2013.

(51) Int. Cl. A47L 13/46; B25G 3/38; B08B 1/00

(52) U.S. Cl. CPC A47L 13/46; B08B 1/006; B08B 1/007; B25G 3/38

(57) ABSTRACT

The present invention relates to a cleaning device and method for cleaning surfaces of homes, vehicles or other large objects. The device includes a support member and a cleaning element. The support member may include a connector configured and dimensioned for receiving and attaching a pole to the support member. The cleaning element may be configured as a mitt having top and bottom portions, with the top portion including an opening for receiving the support member and to allow the pole connector of the support member to pass through, and the bottom portion having front and back surfaces, with the front surface representing a cleaning face and including a plurality of spaced flexible elongated members. The device may further include a wringer for removing dirt trapped in the elongated member or excess cleaning agents or liquid from the cleaning element.

### FIELD OF THE INVENTION

The present invention relates to cleaning devices and in particular to a pole mounted cleaning device having various attachments for cleaning indoor or outdoor surfaces such as interior walls, windows, building siding and rain gutters.

### BACKGROUND OF THE INVENTION

Cleaning large surfaces and components of a person's home or building can not only be time consuming but strenuous and dangerous, as well. For example, cleaning the higher, hard to reach portions of a home or building may require equipment, such as a ladder. Utilizing a ladder while performing cleaning motions, such as scrubbing or painting, can cause the ladder or the person to become unstable. Cleaning a typical home or building's first and second floors would take multiple hours if done with ladders or scaffolding. Also, going up and down the ladder repeatedly to get supplies can be very strenuous and exhausting. These situations could also result in injury. An alternative could be hiring a professional but that can be very costly.

It would be beneficial to develop a tool that is easy to use and works quickly to an individual looking to minimize the amount of time cleaning. The present invention now satisfies that need by providing a device that is a simplified and easy to use to clean various inside or outside surfaces of a home, vehicle or other object that requires cleaning.

### SUMMARY OF THE INVENTION

According to the principles of the invention, a cleaning device is provided, comprising a support member and a cleaning element. The support member includes top and bottom surfaces, wherein the top surface includes a connector configured and dimensioned for receiving and attaching a pole thereto. In one embodiment, the connector includes a pivot means that allows the device to retain flush contact with an surface regardless of application angle. Different cleaning elements are provided depending upon the type of surface to be cleaned.

The cleaning element is associated with the structural support, wherein the cleaning element includes a cleaning face operatively associated with the bottom portion of the support member. The support member is removable from the cleaning element when not in use.

In one embodiment, the cleaning element is configured as a mitt having top and bottom portions, and having a perimeter that includes a protrusion having a pointed tip and a curved portion spaced from the protrusion, wherein the top portion includes an opening for receiving the support member therein and to allow the pole connector of the support member to pass therethrough. The cleaning element includes an opening in the top portion for receiving and enclosing the support member therein and to allow the pole connector of the support member to pass through for connection to the support member. The bottom portion has front and back surfaces, with the front surface representing a cleaning face and including a plurality of spaced flexible elongated members extending the cleaning face, and the back surface operatively associated with the structural support of the support member, which transfers cleaning forces to the cleaning element with the protrusion and pointed tip providing cleaning in confined areas while the curved portion provides uniform forces against a surface to be cleaned when the cleaning element is rotated about the pole.

In another embodiment, the cleaning element includes an external layer that provides the elongated members and an internal layer that includes a porous material. When included, the internal layer provides compressibility to the front surface to assist in conforming to the area to be cleaned. The internal layer can be omitted, however, when it is not desired to transfer too much liquid to a surface, such as when cleaning an interior wall or window.

In yet another embodiment, the external layer and elongated members are made of nylon or microfiber material, with the elongated members being in the form of strands or loops, and the support member is made of a plastic material having sufficient strength and rigidity to provide those properties to the support member. In another embodiment, the flexible elongated members are made of nylon bristles, noodles, loops or strips. While the sizes of the bristles, noodles, loops or strips can vary, when lesser or no liquid pickup is desired, the size would be on the order of approximate dimensions measuring 2 mm diameter by 8 mm long.

In another embodiment, the cleaning element is made of a material that is washable, durable and absorbent so that it can be refreshed between cleaning uses. Typically, the top portion of the cleaning element is made of a flexible material such that the opening can be expanded to receive the support member and to allow the cleaning element to be removable from the support member when not in use. Preferably, the size of the opening is sufficiently large in its expanded state to accommodate the support member and sufficiently small in its original state to prevent the support member from sliding through it during use, thereby securing the support member between the top and bottom portions of the cleaning element.

In another embodiment, the support member can have a rounded shape or be a polygon with circles, ovals, rectangles, squares or triangles. Combinations of such shapes can also be provided depending upon the configurations of the surfaces to be cleaned. In one embodiment, the protrusion is positioned opposite from the curved portion so that the support member has a teardrop shape to allow easy access to hard to reach areas such as corners.

In one embodiment, a foam member is positioned and located between the top surface of the bottom portion of the cleaning element and the bottom portion of the support member. Preferably, the foam member is made of a porous material that provides compressibility to the cleaning face to assist in conforming the cleaning face to an area to be cleaned and to assist in transferring cleaning forces to the cleaning face. The foam member may be part of the internal layer. This construction is preferred for outdoor cleaning or for cleaning surfaces that have an irregular shape or that require relatively larger amounts of liquid to be applied during cleaning. The foam member acts like a sponge to carry additional liquid while its compressible nature allows it to conform to the irregular shape of a surface to be cleaned.

In another embodiment, the cleaning device of the invention further comprises a wringer configured and dimensioned to accommodate the support member enclosed in the cleaning element. The wringer may comprise a top portion comprising top and bottom surfaces, and having areas of multiple holes separated by slightly raised areas; a bottom portion associated with the top portion along the entire border of the bottom surface such that when the wringer is rested on a flat surface, the top portion does not contact said surface directly; and at least one raised portion associated with at least a portion of the border of the top surface of the top portion to assist in removing liquid from the cleaning element. Preferably, the at least one raised portion has at least one opening and a notch configured and dimensioned to accommodate the pole that is attached to the connector of the support member.

According to the principles of the invention, a method for cleaning surfaces is provided, which includes attaching a pole to the connector of the cleaning device of the invention, performing cleaning motions along the surface with the flexible elongated members of the cleaning element, optionally with the addition of a cleaning agent. When the cleaning device of the invention also include a wringer as described herein, the cleaning method may further comprise rubbing the cleaning surface of the cleaning element against the top surface of the wringer to remove any dirt or other objects trapped therein, or pressing the cleaning surface against the top surface of the wringer to remove any excess cleaning agent or liquid.

In one embodiment, upon completion of the cleaning of the surface, removing the support member from the cleaning element so that the cleaning element may be washed or cleaned prior to subsequent usage. Typical surfaces to be cleaned include walls, windows, siding or roof mounted rain gutters or downspouts. The tool can also be used to clean vehicles or other large objects that cannot be reached easily by hand. Thus, the cleaning device when attached to one or more poles of varying length can be used to easily reach vehicle roofs, windows and the like.

### BRIEF DESCRIPTION OF THE FIGURES

The present invention may be understood more fully by reference to the following detailed description of the preferred embodiment of the present invention, illustrative examples of specific embodiments of the invention and the appended figures in which:

FIG. 1 is a perspective view of a support member of the cleaning device of the present invention;

FIG. 2 is a top view of the support member of FIG. 1;

FIG. 3 is a bottom view of the support member of FIG. 1;

FIG. 4 is a front view of the device of FIG. 1;

FIG. 5 is a back view of the support member of FIG. 1;

FIG. 6 is a right view of the support member of FIG. 1;

FIG. 7 is a left side view of the support member of FIG. 1;

FIG. 8 is a perspective view of a wringer of the device of the present invention;

FIG. 9 is a top view of the wringer of FIG. 8;

FIG. 10 is a bottom view of the wringer of FIG. 8;

FIG. 11 is a front view of the wringer of FIG. 8;

FIG. 12 is a back view of the wringer of FIG. 8;

FIG. 13 is a right side view of the wringer of FIG. 8;

FIG. 14 is a left side view of the wringer of FIG. 8;

FIG. 15 is a perspective view of one embodiment of a cleaning element of the device of the present invention;

FIG. 16 is a top view of the cleaning element of FIG. 15;

FIG. 17 is a bottom view of the cleaning element of FIG. 15;

FIG. 18 is a front view of the cleaning element of FIG. 15;

FIG. 19 is a back view of the cleaning element of FIG. 15;

FIG. 20 is a right side view of the cleaning element of FIG. 15;

FIG. 21 is a left side view of the cleaning element of FIG. 15;

FIG. 22 is a perspective view of the device of the present invention, showing the cleaning element, support member, wringer tray and optional support pole;

FIG. 23 is a front view of the device of FIG. 22;

FIG. 24 is a back view of the device of FIG. 22;

FIG. 25 is a right side view of the device of FIG. 22;

FIG. 26 is a left side view of the device of FIG. 22;

FIG. 27 is a top view of the device of FIG. 22;

FIG. 28 is a bottom view of the device of FIG. 22;

FIG. 29 is a perspective view of a second embodiment of a cleaning element of the device of the present invention;

FIG. 30 is a top view of the cleaning element of FIG. 29;

FIG. 31 is a bottom view of the cleaning element of FIG. 29;

FIG. 32 is a detail of the bottom of the cleaning element of FIG. 31;

FIG. 33 is a front view of the cleaning element of FIG. 29;

FIG. 34 is a back view of the cleaning element of FIG. 29;

FIG. 35 is a right side view of the cleaning element of FIG. 29;

FIG. 36 is a left side view of the cleaning element of FIG. 29.

### DETAIL DESCRIPTION OF THE PREFERRED EMBODIMENTS

According to the principles of the invention, a cleaning device is provided, the device comprising a support member and a cleaning element. The support member includes top and bottom portions, wherein the top portion includes a connector configured and dimensioned for receiving and attaching a pole thereto and the bottom portion includes a structural support for providing rigidity to the support member. In one embodiment, the connector includes a pivot means that allows the cleaning device to retain flush contact with an surface regardless of application angle. Different cleaning elements are provided depending upon the type of surface to be cleaned.

The cleaning element is associated with the structural support, wherein the cleaning element includes a cleaning face operatively associated with the bottom portion of the support member. The cleaning element is made of a material that is washable, durable and absorbent and the structural support is removable from the cleaning element when not in use.

In one embodiment, the cleaning element is configured as a mitt having a front and back surfaces and an opening for receiving and enclosing the support member therein. The front surface representing the cleaning face and including a plurality of spaced flexible elongated members are extended from the cleaning face. The back surface includes an opening to allow the pole connector of the support member to pass through.

In another embodiment, the cleaning element includes an external layer that provides the elongated members and an internal layer that includes a porous material. The internal layer provides compressibility to the front surface to assist in conforming to the area to be cleaned.

In yet another embodiment, the external layer and elongated members are made of nylon or microfiber material and the support member is made of a plastic material having sufficient strength and rigidity to provide those properties to the support member. In another embodiment, the flexible elongated members are made of nylon bristles, noodles, loops or strips. The sizes of the bristles, noodles, loops or strips can vary depending upon the amount of liquid to be carried or the roughness of the surface to be cleaned. Approximate suitable dimensions would be between 0.5 mm in diameter or width to about 5 mm with a length of 5 to 25 mm. The preferred dimensions for noodles would be from 1 to 5 mm diameter by 5 to 12 mm long, for bristles, the dimensions would be 0.5 to 2 mm diameter to 5 to 25 mm in length, while for loops or strips, the dimensions would be from 1 to 5 mm wide and 0.5 to 2 mm thick, with a length of from 5 to 25 mm.

In one embodiment, the mitt includes an enclosing means to further secure the support member between the front and back surfaces but that allows the mitt to be removable from the support member when not in use. The opening of the mitt may include a closure element, which includes mating portions for joining the front and back surfaces while securing the support member in between the front and back surfaces. In other embodiments, the closure element includes hook and loop fasteners, a zipper, male and female snaps, or a button and hole arrangement.

In one embodiment, a foam member is positioned and located between the cleaning face of the cleaning element and the bottom portion of the support member. Preferably, the foam member is made of a porous material that provides compressibility to the cleaning face to assist in conforming the cleaning face to an area to be cleaned and to assist in transferring cleaning forces to the cleaning face. The foam member may be part of the internal layer.

In another embodiment, the cleaning element includes an alignment plate that is removably engageable with the structural support of the support member and a plurality of flexible elongated members extending from the plate for providing cleaning engagement with a surface to be cleaned. Preferably, one of the alignment plate and structural support includes apertures and the other of the alignment plate and structural support includes protuberances that engage the apertures to provide a secure attachment between the alignment plate and structural support.

In another embodiment, one of the alignment plate and structural support includes a rail and the other of the alignment plate and structural support includes a channel that allows sliding movement of the rail therein to provide a secure attachment between the alignment plate and structural support. Preferably, as disclosed herein, the shape of the support member is generally in the form of a teardrop. This shape includes a protrusion that has a pointed tip and a curved portion. Other configurations can also be present, i.e., multiple protrusions or curved portions, if desired. In another embodiment, the shape of the support member can be rounded, a polygon or combinations thereof with circles, ovals, rectangles, squares or triangles being representative. Combinations of such shapes can also be provided depending upon the configurations of the surfaces to be cleaned.

According to the principles of the invention, a method for cleaning surfaces is provided, which includes attaching a pole to the connector of the cleaning element, performing cleaning motions along the surface with the flexible elongated members of the cleaning element, optionally with the addition of a cleaning agent. In one embodiment, upon completion of the cleaning of the surface, removing the support member from the cleaning element so that the cleaning element may be washed or cleaned prior to subsequent usage. Typical surfaces to be cleaned include walls, windows, siding, or roof mounted rain gutters or downspouts.

The present method and device will be described in connection with the figures, it being understood that the description and figures are for illustrative, non-limiting purposes.

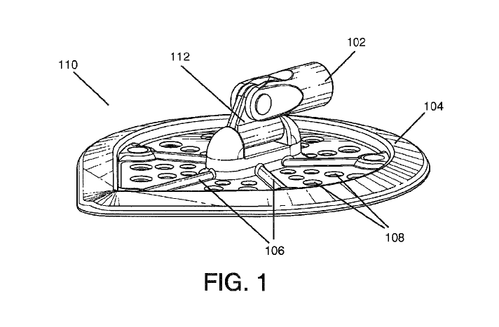

With reference to FIG. 1, illustrated is an exemplary support member of a device for cleaning surfaces. FIG. 1 illustrates a perspective view of one embodiment of the support member 110. The support member 110 includes a connector 102 for receiving and attaching a pole to the support member 110. The type of pole may be any standard handle or extension pole. The connector 102 may also include universal threads to screw the pole into the connector for added stability. The connector 102 may include internal thread, which mate with external threads that are provided at the end of the pole (not shown). The connection for attaching the pole can be added to the support member 110 in a fixed position or in an adjustable position. The pole length is selected based on the location that has to be cleaned and typically will be between five and twenty-five feet. The connector 102 may also include a pivot means 112 to provide for flexible motion of the device that allows the device to remain flush contact with the surface regardless of the application angle. The pivot means 112 may allow for rotation or multi-angle maneuverability of the device.

The support member 110 has a slightly raised border 104. Ribs 106 connect the connector 102 to the raised border 104 to improve the overall strength and structural integrity of the support member 110. The support member 110 also include multiple holes 108 to reduce the overall weight of the support member 110 without sacrificing its strength and rigidity.

The support member 110 can be made of many different types of materials. For example, the support member 110 may be made of plastic, metal, or any other type of material that provides rigidity and support to the cleaning element (not shown) while being lightweight. The support member 110 has a number of utilities. It provides support, rigidity and strength to the cleaning element (not shown) that are attached hereto.

The support member 110 is configured so that when pressed against the surface to be cleaned by the pole, it will exert sufficient cleaning pressure to remove dirt, debris or other contamination from that surface. The support member 110 also needs to be big enough to allow quick cleaning of substantial surface area at a time but not so large that the combination of the support member 110 and the cleaning element (not shown) is overly heavy and difficult to work with for projects requiring height.

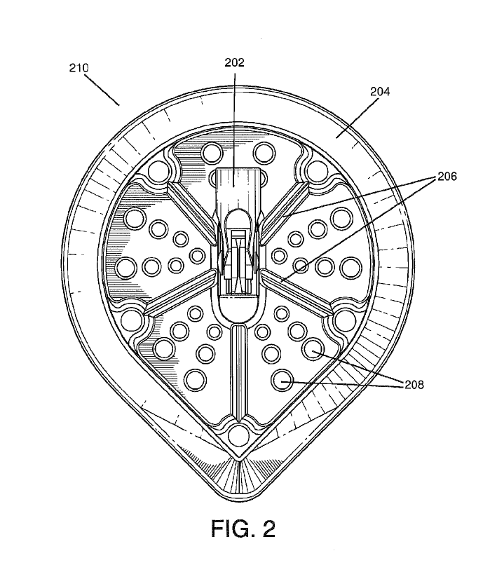

FIG. 2 shows a top view of the exemplary support member illustrated in FIG. 1. The support member 210 has a teardrop shape, which advantageously provides a protrusion that terminations preferably at a tip formed by an angular point to allow easy access to and clean tight spots, such as nooks, crannies, and various angles on the walls of a house or building. The tip is preferably formed at an acute angle so that it can easily conform to corners or other confined spaces for cleaning thereof. Any acute angle can be provided but around 20 to 45 degrees is preferred.

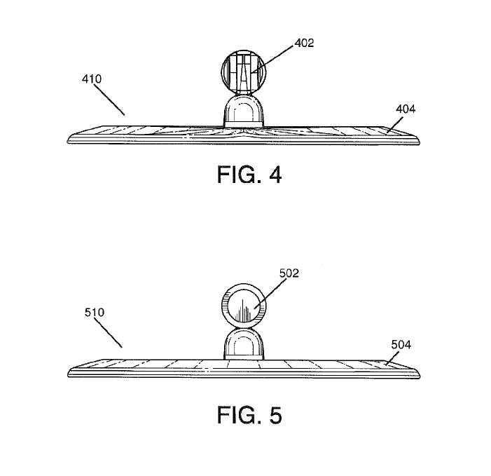

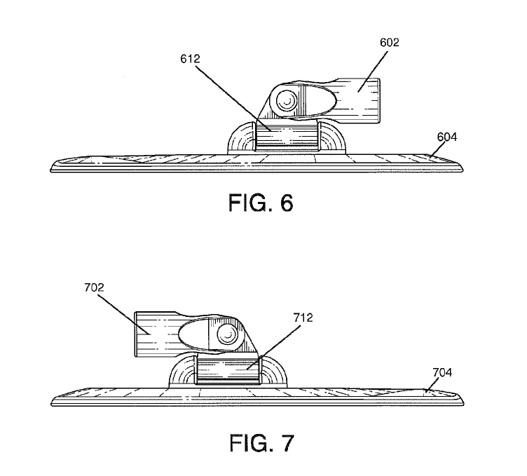

FIGS. 4-7 are side views of the exemplary support member illustrated in FIG. 1.

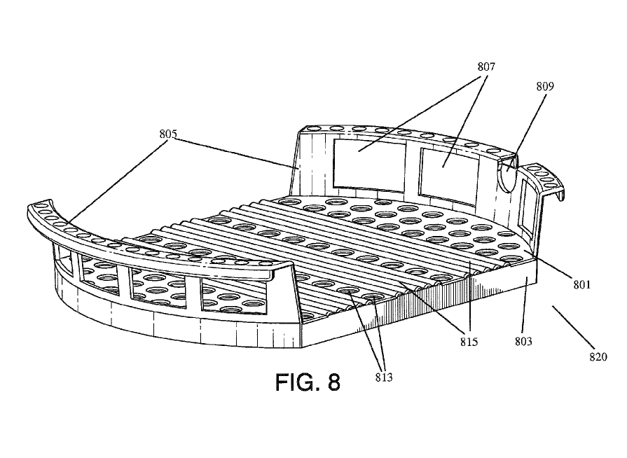

FIG. 8 illustrates an exemplary wringer. The wringer 820 has a top portion 801 having areas of multiple holes 813 separated by slightly raised areas 815; a bottom portion 803 associated with the top portion 801 along the entire border of the bottom surface such that when the wringer is rested on a flat surface, the top portion 801 does not contact said surface directly; and raised portions 805 along a portion of the border of the top surface of the top portion 801. The raised portions 805 have multiple openings 807 and a notch 809 configured and dimensioned to accommodate the pole that is attached to the connector of the support member (not shown).

The raised portions in combination with the multiple holes facilitates removal of liquids from the cleaning element by engaging the wringer with the element.

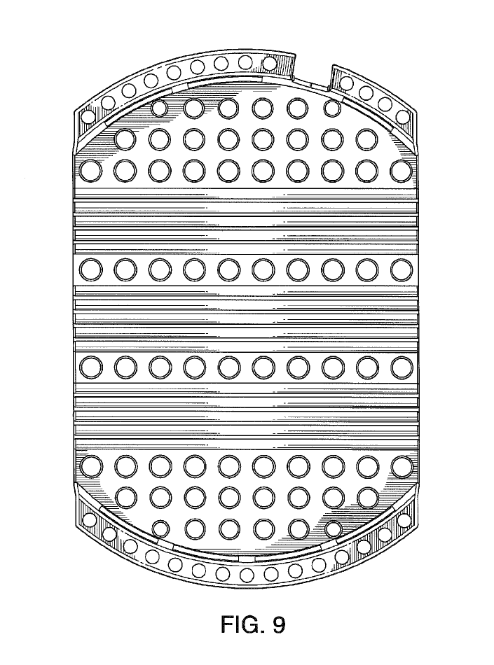

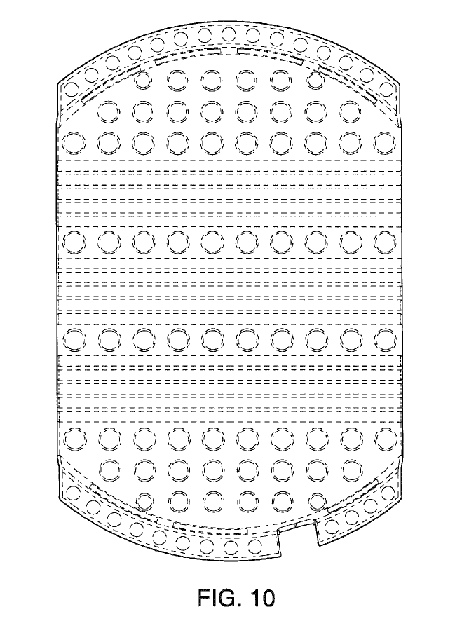

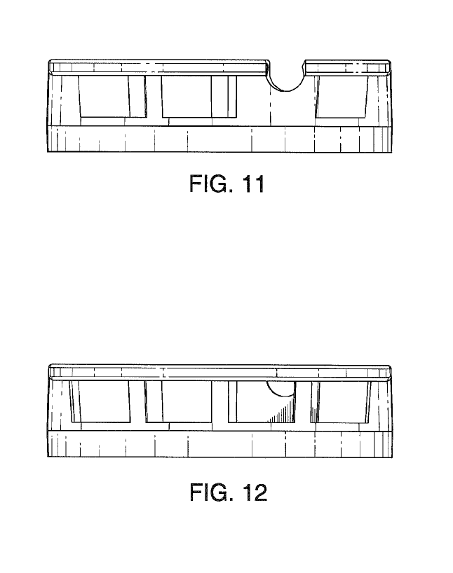

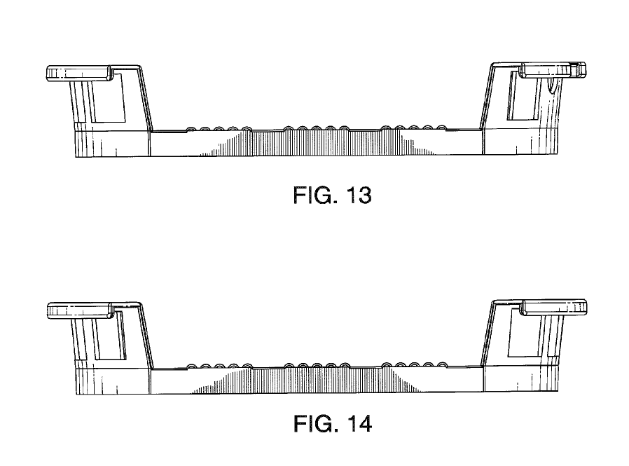

FIGS. 9 and 10 shows a top view, and FIGS. 11-14 show side views of the exemplary wringer illustrated in FIG. 8.

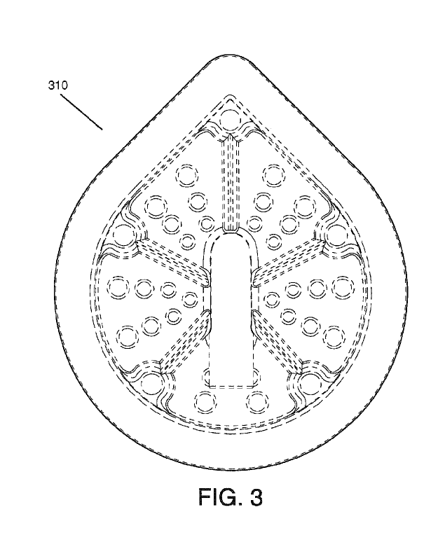

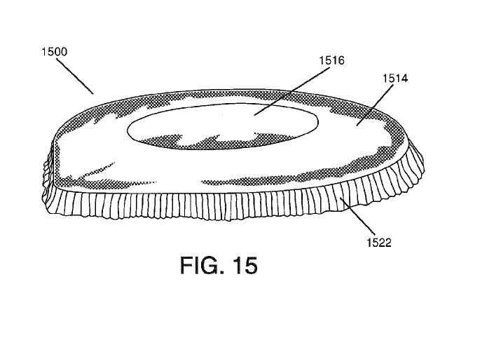

FIG. 15 illustrates a perspective view of one embodiment of the cleaning element 1500 that encloses the support member of FIGS. 1-7. In this embodiment, the cleaning element is configured as a mitt having a top portion 1514, which includes an opening 1516 for receiving and accommodating the support member. The bottom portion of the cleaning element includes a plurality of spaced flexible elongated members 1522. The top portion 1514 and the elongated members 1522 may be made of a microfiber or similar material.

The cleaning element 1500 may include an external layer and an internal layer (not shown). The internal layer may be made of a porous material that provides compressibility to the cleaning surface of the cleaning element to assist in conforming to an area to be cleaned. The porous material may include different types of material that provide these functionalities, such as foam, sponges, etc. The porous material should not be too absorbent so as to retain too much water or liquid that would cause using the device at great heights to be more difficult and tiring. The internal layer may be attached to the external layer or the internal layer may be removable.

The cleaning element 1500 is made of a material that is washable, durable and absorbent. The cleaning element 1500 may be made of microfiber or similar materials. The material of the cleaning element 1500 and the elongated members 1522 need to be strong enough to handle occasional rough surfaces yet soft enough not to scratch paint or surfaces. The elongated members 1522 may also be made of a material that provides some fiction or grip to allow for more thorough cleaning. The elongated members 1522 may be soft and flexible or more firm. The elongated members 1522 can be made of a polymeric material, especially one that is of nylon or other plastic or polymeric material that is somewhat resistant to abrasion. The elongated members 1522 can be made of nylon but can also be of a microfiber-type material as long as the material provides a texture that facilitates the removal of dirt or debris from the surface to be cleaned.

When cleaning the side of a house, the cleaning element 1500 and the elongated members 1522 need to conform to the edges between siding panels or to irregular areas, such as where windows or other openings are provided in the house walls. To provide compressibility to the cleaning member 1500, compressible materials, such as sponge or foam made of polyurethane, foam PVC, or other convention foam materials, can be attached to the internal layer of the cleaning element 1500, or can be provided as a separate item that is placed between the support member 110 and cleaning element 1500. The compressibility of the cleaning element 1500 allows the elongated members 1522 to conform to irregular surfaces, such as the surfaces of siding, gutters, downspouts, etc.

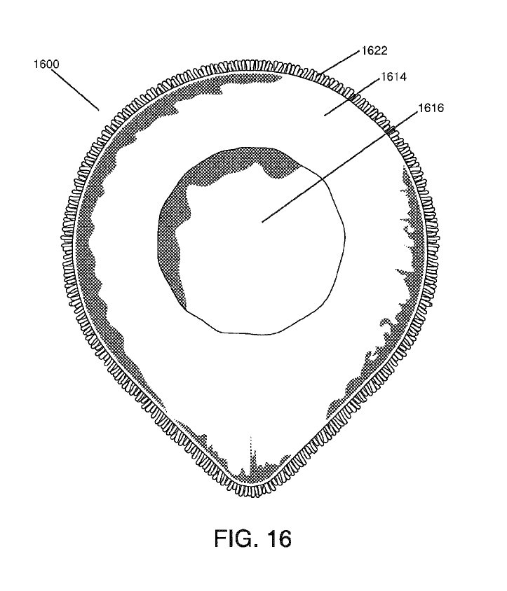

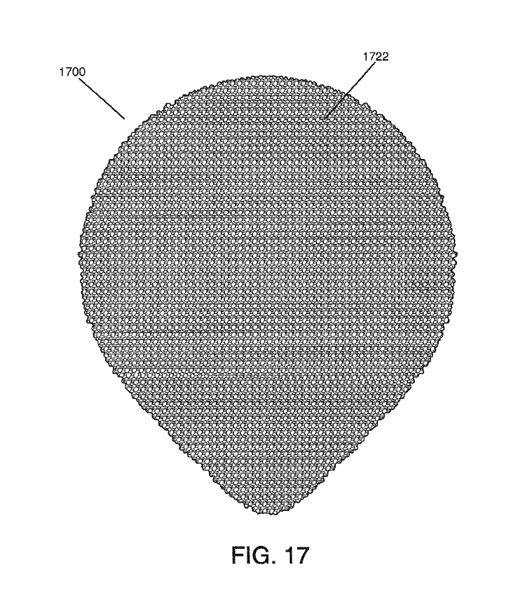

FIGS. 16 and 17 show a top view and a bottom view, respectively, of the cleaning member illustrated in FIG. 15. The cleaning member 1600, 1700 has a teardrop shape, which advantageously provides an angular point to allow easy access to and clean tight spots, such as nooks, crannies, and various angles on the walls of a house or building.

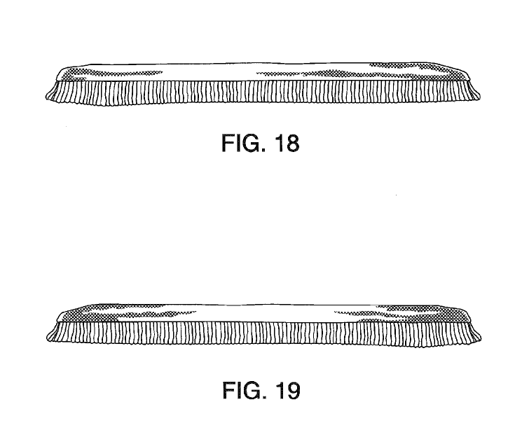

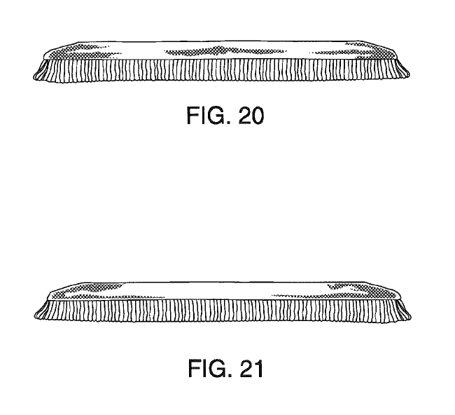

FIGS. 18-21 are side views of the exemplary cleaning element illustrated in FIG. 15.

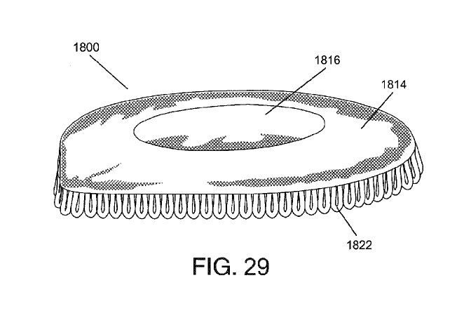

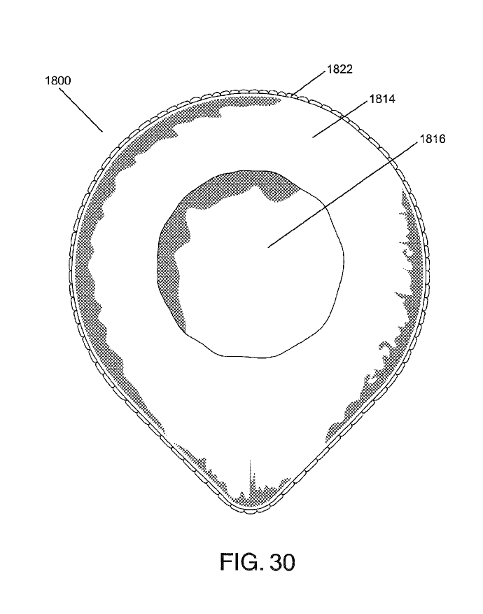

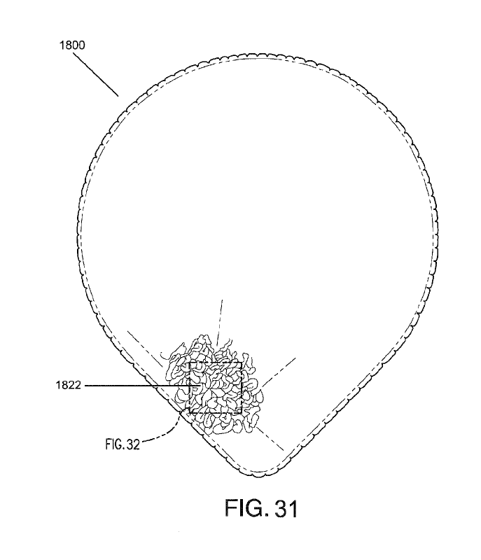

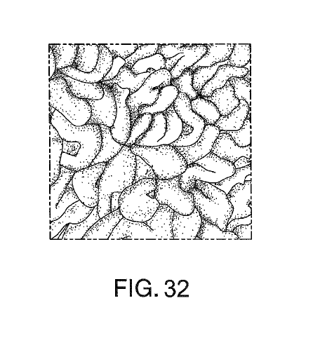

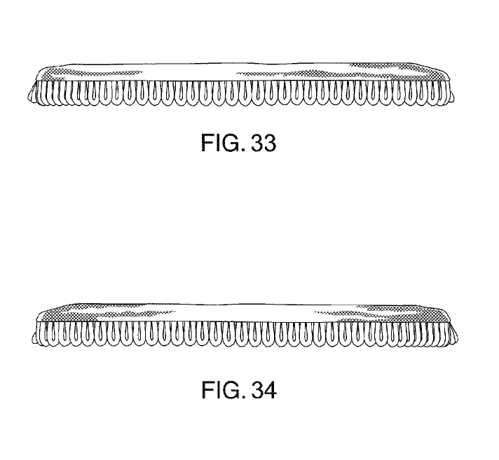

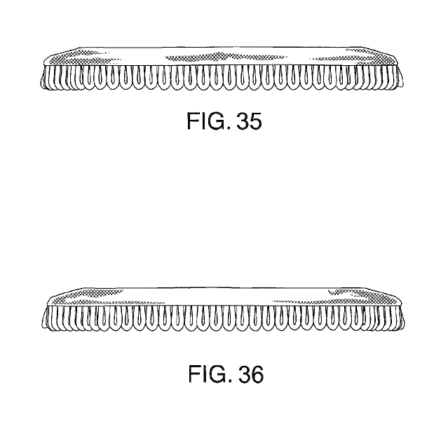

FIG. 29 illustrates a perspective view of another cleaning element 1800 that also encloses the support member of FIGS. 1-7. In this embodiment, the cleaning element is configured as a mitt having a top portion 1814, which includes an opening 1816 for receiving and accommodating the support member. The bottom portion of the cleaning element includes a plurality of spaced flexible elongated members 1822. The top portion 1814 and the elongated members 1822 may be made of a microfiber or similar material. Unlike the embodiment of FIG. 15, however, this cleaning element 1800 includes a plurality of looped elongated members 1822. These are also shown in more detail in FIGS. 30 and 31. As the loops 1822 overlap and have open spaces, they provide superior cleaning action compared to the elongated members 1522 of FIG. 15.

The cleaning element 1800 may include an external layer and an internal layer that is made of a porous material that provides compressibility to the cleaning surface of the cleaning element to assist in conforming to an area to be cleaned. The porous material may include different types of material that provide these functionalities, such as foam, sponges, etc. The porous material should not be too absorbent so as to retain too much water or liquid that would cause using the device at great heights to be more difficult and tiring. The internal layer may be attached to the external layer or the internal layer may be removable.

The cleaning element 1800 is preferably made of a material that is washable, durable and absorbent. The cleaning element 1800 is typically made of microfiber or similar materials. The material of the cleaning element 1800 and the elongated loop members 1822 need to be strong enough to handle occasional rough surfaces yet soft enough not to scratch paint or surfaces. The elongated loop members 1822 may also be made of a material that provides some fiction or grip to allow for more thorough cleaning. Alternatively, the elongated loop members 1822 may be soft and flexible or more firm. The elongated loop members 1822 are typically made of a polymeric material, especially one that is of nylon or other plastic or polymeric material that is somewhat resistant to abrasion. The elongated loop members 1822 are most preferably made of nylon or other microfiber-type material as long as the material provides a texture that facilitates the removal of dirt or debris from the surface to be cleaned.

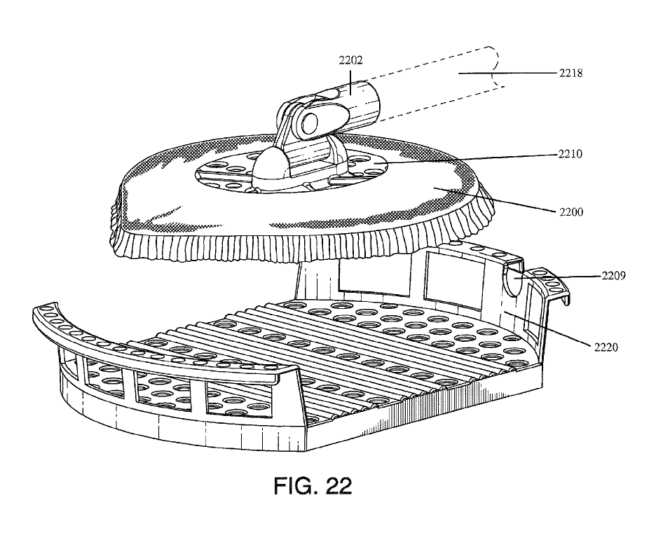

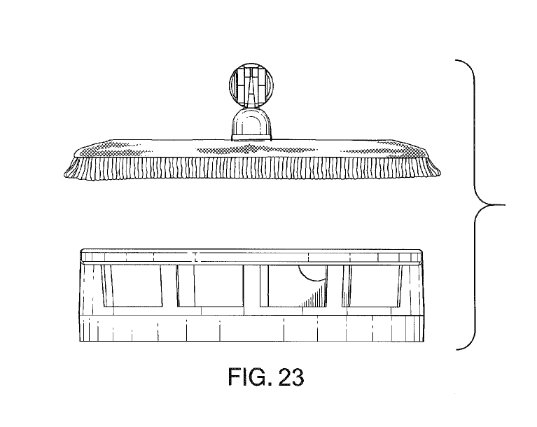

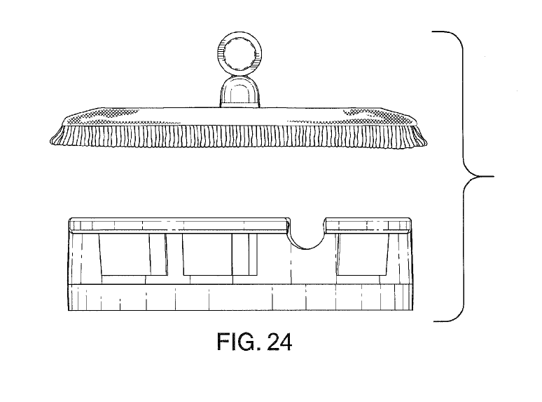

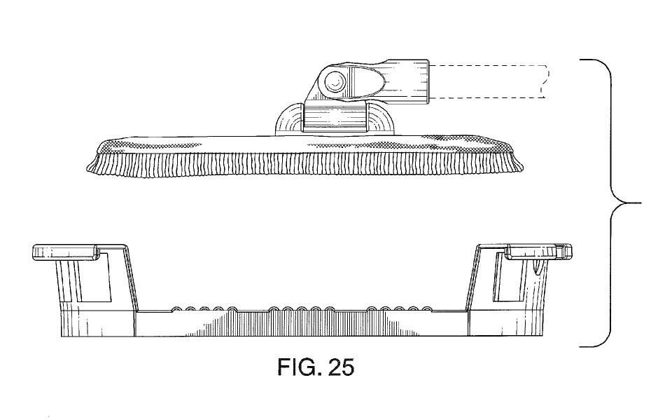

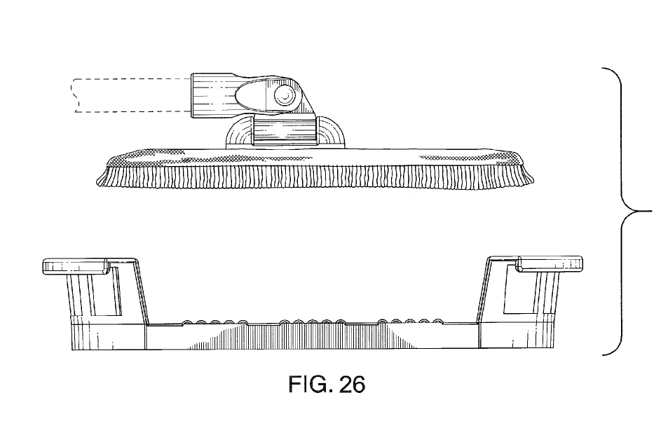

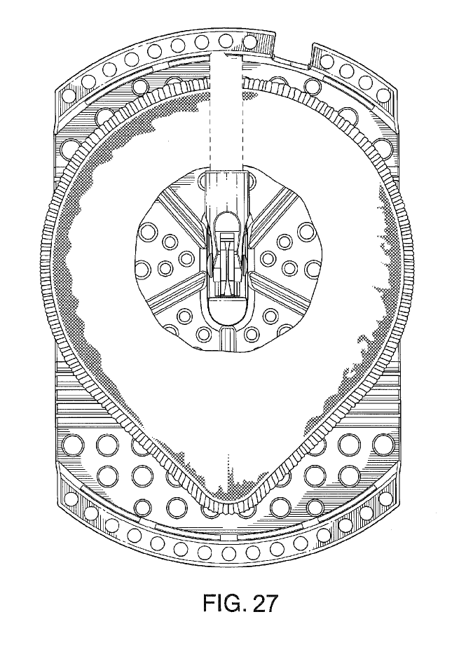

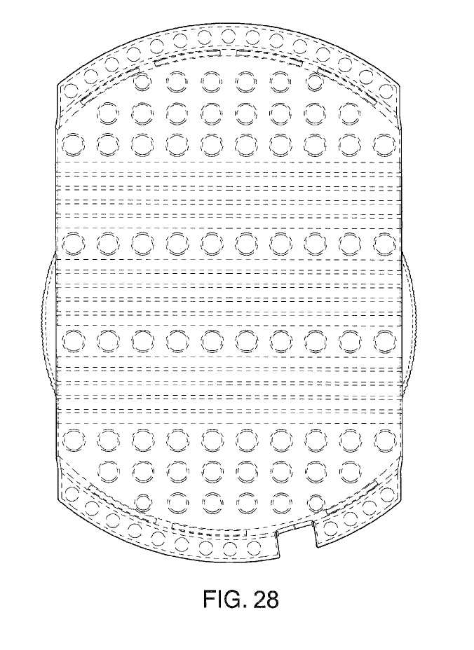

As in FIG. 15, when cleaning the side of a house, the cleaning element 1800 and the elongated loop members 1822 conform to the edges between siding panels or to irregular areas, such as where windows or other openings are provided in the house walls. To provide compressibility to the cleaning member 1800, compressible materials, such as sponge or foam made of polyurethane, foam PVC, or other convention foam materials as noted herein, can be attached to the internal layer of the cleaning element 1800, or can be provided as a separate item that is placed between the support member 110 and cleaning element 1800. The compressibility of the cleaning element 1800 allows the elongated loop members 1822 to conform to irregular surfaces, such as the surfaces of siding, gutters, downspouts, etc. FIG. 22 shows a perspective view of an exemplary device having a support member 2210 enclosed in a cleaning element 2200 and an exemplary wringer 2220. When the support member 2210 enclosed in the cleaning element 2200 is placed on the wringer 2220, the pole 2218 attached to the connector 2202 of the support member 2210 can rest on the notch 2209 of the wringer 2220. FIGS. 23-28 illustrate additional views of the overall device. As noted, in a preferred embodiment, a pole is attached to the support member to reach higher areas on the building. If the area to be cleaned is in proximity to the user, the pole member is not required and the device shown in FIG. 22 can be used as is, with the wringer used to remove excess water from the cleaning element or mitt 2200 when desired.

An exemplary process of the present invention for cleaning surfaces includes attaching a pole to the connector of the cleaning element. As discussed above, the pole is preferred for a longer reach, and it may include any number of handles, extension poles, etc. The pole also may attach to the connecter of the support member through a universal thread by screwing the pole into the connector. As discussed above, the connector may also include a pivot means for providing a pivot function between the pole and the device.

A cleaning agent is preferably used to assist in the cleaning operation. This agent can be water alone or a solution of water and a detergent or other dirt dissolving or removing chemicals. The cleaning solution may be any number of solutions, such as water, ammonia, or any other cleaning agent suited for cleaning the walls of a home or building. A proprietary solution known as the Chomp Gutter & Metal Trim Cleaner is preferably used as the cleaning solution for optimal results when cleaning home rain gutters. This solution is simply added to water in a bucket. The cleaning device comprising the support member enclosed in the cleaning element is immersed into the solution, which is then pressed against the wringer to remove excess solution, before being applied to clean the surface. In addition, it is also possible to pre-wet the surface to be cleaned with water or to prewash it with a spray of chemical cleaning agent before applying the cleaning device thereto. A skilled artisan can easily determine the optimum cleaning sequence depending on the type of surface to be cleaned and the degree of dirt contamination.

A person cleaning the walls of a home or building would hold the pole and position the device on the desired surface to be cleaned, such that the cleaning face of the cleaning element and the elongated members is placed against the surface to be cleaned. Then, performing cleaning motions along the surface with the flexible elongated members of the cleaning element. Cleaning motions may include any number of motions, including but not limited to, wiping, scrubbing, scraping, rubbing, etc.

Upon completion of the cleaning process of the surface, the support member can be removed from the cleaning element so that the cleaning element may be washed or otherwise cleaned prior to subsequent use. For example, after cleaning the siding or gutters of a house or building, the cleaning element would most likely be very dirty. It is very convenient that the support member is removable from the cleaning element so that the cleaning element may be cleaned. Because the support member is enclosed within the cleaning element, it is most likely that the support member does not need to be cleaned but in the event that it does need to be cleaned, the support member is made of a material that is easy to clean, such as a plastic material. Therefore, the support member may be easily just rinsed off with some soap and water and wiped clean. The cleaning element may be washed in a washing machine with regular laundry detergent or hand washed.

Features or characteristics described in one context, process, or device are applicable to other context, process or devices described herein. The steps of the processes illustratively described herein can be performed in a different order, if desired. Also, steps could be added or removed from the processes illustratively described herein. The processes illustratively described herein can be implemented using the described examples of hardware and network configurations.

The terms and expressions which have been employed in the specification are used as terms of description and not of limitations, there is no intention in the use of such terms and expressions to exclude any equivalents of the features shown and described or portions thereof, but it is recognized that various modifications are possible within the scope of the claims to the invention.

1. A cleaning device comprising:
a support member that includes a support made of plastic or metal and having top and bottom surfaces and a periphery, and a raised border about the periphery configured and dimensioned to improve the overall strength and structural integrity of the support member, the support member having a shape that includes a point for providing access to corner areas to be cleaned, wherein the top surface of the support includes a pivot member supporting a connector configured and dimensioned for receiving and attaching a pole thereto in order to provide flexible motion to the cleaning device; and
a cleaning element configured as a mitt having top and bottom portions, and having a perimeter that includes a protrusion having a pointed tip and a curved portion spaced from the protrusion, wherein the top portion includes an opening for receiving the support member therein and to allow the pole connector of the support member to pass therethrough, wherein the bottom portion has front and back surfaces, with the front surface representing a cleaning face and including a plurality of spaced flexible elongated members extending therefrom, and the back surface operatively associated with the bottom surface of the support member, wherein the support member transfers cleaning forces to the cleaning element with the protrusion and pointed tip providing cleaning in confined areas while the curved portion provides uniform forces against a surface to be cleaned when the cleaning element is rotated about the pole.

2. The device of claim 1, wherein the protrusion is positioned opposite from the curved portion so that the support member has a teardrop shape that allows easy access to hard to reach areas, and wherein the support further comprises radial ribs for reinforcement and a plurality of holes to reduce overall weight of the support member while not sacrificing its strength and rigidity.

3. The device of claim 2, wherein the cleaning element comprises an external layer, the external layer and the elongated members are made of nylon or microfiber material, with the elongated members being in the form of strands or loops, and the support member is made of a plastic material having sufficient strength and rigidity to provide those properties to the support member.

4. The device of claim 2, wherein the cleaning element is made of a material that is washable, durable and absorbent so that it can be refreshed between cleaning uses, with its top portion made of a flexible material such that the opening can be expanded to receive the support member and to allow the cleaning element to be removable from the support member when not in use.

5. The device of claim 4, wherein the size of the opening is large enough in its expanded state to accommodate the support member and small enough in its original state to prevent the support member from sliding through it during use, thereby securing the support member between the top and bottom portions of the cleaning element.

6. The device of claim 1, further comprising a foam member positioned and located between the top surface of the bottom portion of the cleaning element and the bottom surface of the support member, the foam member comprising porous material that provides compressibility to the cleaning face to assist in conforming the cleaning face to an area to be cleaned and to assist in transferring cleaning forces or cleaning liquid to the cleaning face.

7. A cleaning device comprising:
a support member that includes a support made of plastic or metal and having top and bottom surfaces, the support member having a shape that includes a point for providing access to corner areas to be cleaned, wherein the top surface of the support includes a connector configured and dimensioned for receiving and attaching a pole thereto; and
a cleaning element configured as a mitt having top and bottom portions, and having a perimeter that includes a protrusion having a pointed tip and a curved portion spaced from the protrusion, wherein the top portion includes an opening for receiving the support member therein and to allow the pole connector of the support member to pass therethrough, wherein the bottom portion has front and back surfaces, with the front surface representing a cleaning face and including a plurality of spaced flexible elongated members extending therefrom, and the back surface operatively associated with the bottom surface of the support member, wherein the support member transfers cleaning forces to the cleaning element with the protrusion and pointed tip providing cleaning in confined areas while the curved portion provides uniform forces against a surface to be cleaned when the cleaning element is rotated about the pole; and
a wringer configured and dimensioned to accommodate the support member enclosed in the cleaning element, the wringer comprising:
a top portion comprising top and bottom surfaces, and having areas of multiple holes, and with the top surface including rows of linear, slightly raised areas, with the areas of multiple holes separated by plural rows of the slightly raised areas;
a bottom portion associated with the top portion along the entire border of the bottom surface such that when the wringer is rested on a flat surface, the top portion does not contact said surface directly; and
at least one raised side portion associated with at least a portion of the border of the top surface of the top portion,
wherein the holes and rows of slightly raised areas on the top surface assist in removing liquid from the cleaning element when the cleaning element engages the top surface of the top portion between the at least one raised side portion.

8. A cleaning device comprising:
a support member that includes a support made of plastic or metal and having top and bottom surfaces and a periphery, and a raised border about the periphery configured and dimensioned to improve the overall strength and structural integrity of the support member, the support member having a shape that includes a point for providing access to corner areas to be cleaned, wherein the top surface of the support includes a pivot member supporting a connector configured and dimensioned for receiving and attaching a pole thereto in order to provide flexible motion to the cleaning device; and
a cleaning element configured as a mitt having top and bottom portions, and having a perimeter that includes a protrusion having a pointed tip and a curved portion spaced from the protrusion, wherein the top portion includes an opening for receiving the support member therein and to allow the pole connector of the support member to pass therethrough, wherein the bottom portion has front and back surfaces, with the front surface representing a cleaning face and including a plurality of spaced flexible elongated members extending therefrom, and the back surface operatively associated with the bottom surface of the support member, wherein the support member transfers cleaning forces to the cleaning element with the protrusion and pointed tip providing cleaning in confined areas while the curved portion provides uniform forces against a surface to be cleaned when the cleaning element is rotated about the pole; and
a wringer configured and dimensioned to accommodate the support member enclosed in the cleaning element, the wringer comprising:
a top portion comprising top and bottom surfaces, and having areas of multiple holes separated by slightly raised areas;
a bottom portion associated with the top portion along the entire border of the bottom surface such that when the wringer is rested on a flat surface, the top portion does not contact said surface directly; and
at least one raised portion associated with at least a portion of the border of the top surface of the top portion to assist in removing liquid from the cleaning element,
wherein the at least one raised portion has at least one opening and a notch configured and dimensioned to accommodate the pole that is attached to the connector of the support member.

9. The device of claim 1, wherein the connector further comprises pivot means that allows the device to retain flush contact with an surface regardless of application angle.

10. A method for cleaning surfaces, which comprises:
attaching a pole to the connector of the cleaning device of claim 1; and
performing cleaning motions along the surface with the flexible elongated members of the cleaning element, optionally with the addition of a cleaning agent.

11. The method of claim 10, wherein upon completion of the cleaning of the surface, removing the support member from the cleaning element so that the cleaning element may be washed or cleaned prior to subsequent usage.

12. The method of claim 10, wherein the surface is a wall, window, siding, rain gutter or downspout.

13. A method for cleaning surfaces, which comprises:
attaching a pole to the connector of the cleaning device of claim 7;
performing cleaning motions along the surface with the flexible elongated members of the cleaning element; and
rubbing the cleaning surface of the cleaning element against the top surface of the wringer to remove any dirt or other objects trapped therein.

14. A for cleaning surfaces, which comprises:
attaching a pole to the connector of the cleaning device of claim 8; and
performing cleaning motions along the surface with the flexible elongated members of the cleaning element; and
rubbing the cleaning surface of the cleaning element against the top surface of the wringer to remove any dirt or other objects trapped therein.

15. The method of claim 14, wherein upon completion of the cleaning of the surface, removing the support member from the cleaning element so that the cleaning element may be washed or cleaned prior to subsequent usage.

16. The method of claim 14, wherein the surface is a wall, window, siding, rain gutter or downspout.

17. The method of claim 13 further comprising:
adding a cleaning agent to the cleaning surface prior to performing the cleaning motions; and
pressing the cleaning surface against the top surface of the wringer to remove any excess cleaning agent.

18. The method of claim 17, wherein upon completion of the cleaning of the surface, removing the support member from the cleaning element so that the cleaning element may be washed or cleaned prior to subsequent usage.

19. The method of claim 17, wherein the surface is a wall, window, siding, rain gutter or downspout.

20. The method of claim 13 further comprising adding a cleaning agent to the cleaning surface prior to performing the cleaning motions.
